(19) United States
(12) Patent Application Publication
(10) Pub. No.: US 2003/0142075 A1
(43) Pub. Date: Jul. 31, 2003

(54) Modulated optical mouse for a personal computer

(75) Inventor: Yuan-Cheng Chin, Hsintien City (TW)

Correspondence Address: BACON & THOMAS, PLLC, 625 SLATERS LANE, FOURTH FLOOR, ALEXANDRIA, VA, 22314

(73) Assignee: Unity Opto Technology Co., Ltd., San Chung City (TW)

(21) Appl. No.: 10/057,918

(22) Filed: Jan. 29, 2002

(51) Int. Cl. G09G 5/08

(52) U.S. Cl. 345/163

(57) ABSTRACT

An optical mouse has a light emitting diode (LED) and a projecting lens located on a reflection path of the LED so as to project the light of the LED to the sensor. After the sensor picks up the signal from the LED, the signal is readily sent to the computer so as to simplify the structure and reduce the manufacturing cost of the optical mouse.

### BACKGROUND OF THE INVENTION

1. Field of the Invention

The present invention relates to an optical mouse, and more particularly to a modulated optical mouse for a personal computer. The modulated optical mouse has a light emitting diode (LED), a sensing element and a projecting lens all of which are integrally formed into a module so as to simplify the structure of the optical mouse and reduce the cost.

2. Description of Related Art

Normally, a computer mouse includes a housing composed of a top cover and a base. The base has a hole and a circuit board mounted on the base and having a tracking moduler corresponding to the hole and a wire connected to the host of the computer. The tracking moduler has a tracking ball. With such an arrangement, the movement of the tracking ball is able to be transformed into digital signal and sent to the host of the computer so as to accomplish the purpose of signal transmission. However, this kind of computer mouse needs to be connected to the host by means of the wire and to move on a reflection surface (table). Therefore, the movement of the computer mouse is limited by the length of the wire and also the space available on the reflection surface. Furthermore, due to a long period of time rolling on the reflection surface, the tracking ball is easily contaminated by the dust on the reflection surface and thus causes malfunction to the tracking moduler.

In order to overcome the shortcoming, another optical mouse is invented. With reference to FIGS. 11 and 12, a conventional mouse as disclosed in U.S. Pat. No. 6,281,882 includes a base 91, a top cover (not shown), a lens member 92 and a circuit board 93. The circuit board 93 is securely mounted on the base 91 and has a light emitting diode 94 and a sensor 95 mounted thereon. Under the circuit board 93 is the lens member 92, so that the light from the LED 92 is able to pass through the first lens 921 and the reflection lens 923 and then refract to the table 96. The light is then reflected to the second lens 922 and consequently picked up by the sensor 95. The circuit board 93 of this kind has to have a control IC, LED 94, sensor 95 and the lens member 92 which is corresponding to the LED 94, the sensor 95 and the base 91. The total cost of this optical mouse for personal computer is high and it is quite difficult for the user to precisely align the optical path for the reflection and refraction of the light from the LED 92.

To overcome the shortcomings, the present invention intends to provide an improved optical mouse to mitigate or obviate the aforementioned problems.

### SUMMARY OF THE INVENTION

The primary objective of the invention is to provide a modulated optical mouse for a personal computer. The optical mouse has a light emitting diode (LED), a sensor, an optical lens and a control element integrally formed on a module so that there is no need for the user to have individual inventory for each of the parts. As a consequence of this modulated optical mouse, manufacturing cost is kept low.

Another objective of the invention is to provide a modulated optical mouse for a personal computer, which eliminates the need for the reflection lens so as to simplify the structure and reduce cost.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of an optical mouse of the present invention;

FIG. 2 is an exploded perspective view of the optical mouse of the first embodiment of the present invention;

FIG. 3 is a side plan view with partial in section of the first embodiment of the optical mouse in FIG. 1;

FIG. 4 is a perspective view of a second preferred embodiment of the optical mouse of the present invention;

FIG. 5 is a schematic view showing the relationship of parts in the second embodiment of the present invention;

FIG. 6 is a schematic view showing the relationship of parts in a third embodiment of the present invention;

FIG. 7 is a side plan view with partial in section of the fourth embodiment of the optical mouse of the present invention;

FIG. 8 is a schematic view showing the relationship of parts in the fourth embodiment of the present invention;

FIG. 9 is a schematic view showing the relationship of parts in the fifth embodiment of the present invention;

FIG. 10 is a side plan view with partial in section of the sixth embodiment of the present invention;

FIG. 11 is an exploded perspective view of a conventional optical mouse; and

FIG. 12 is a schematic sectional view of the conventional optical mouse in FIG. 11.

### DETAILED DESCRIPTION OF PREFERRED EMBODIMENT

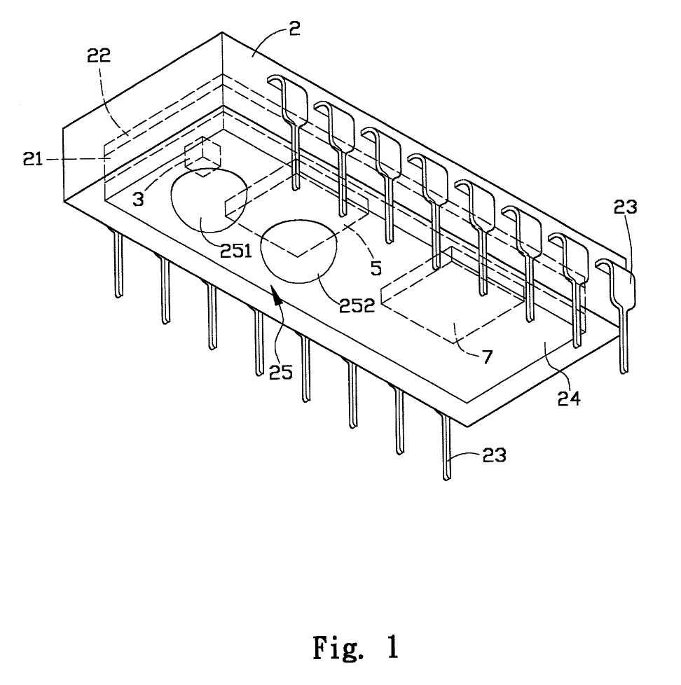

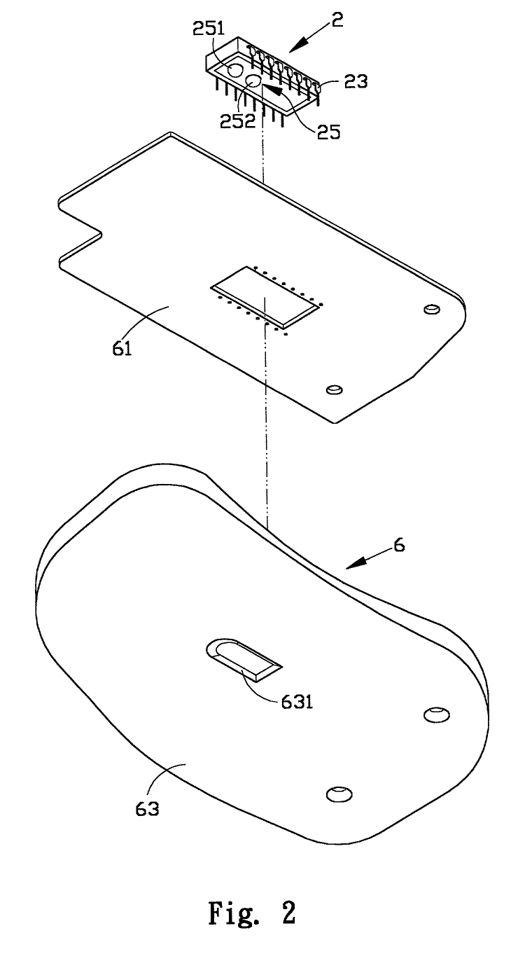

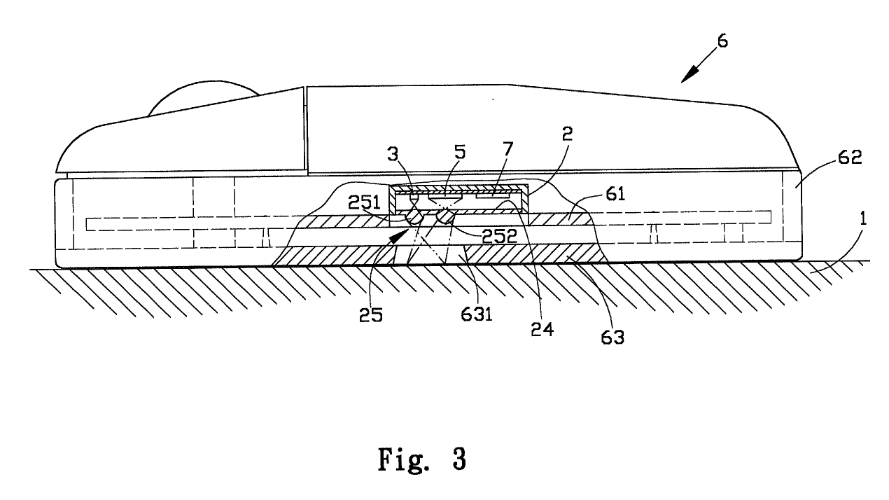

With reference to FIGS. 1, 2 and 3, the optical mouse in accordance with the present invention has a body 2, at least one LED 3 (light emitting diode), a sensor 5, an optical element 25 and at least one control element 7.

The body 2 has a predetermined space 21 defined inside the body 2 and having at least one lead 22 securely provided inside the space 21 and feet 23 each electrically connected to one of the feet 23.

The LED 3 is mounted inside the space 21 to electrically connect with the lead 22. The LED 3 is at the bottom of the body 2 and is able to emit visible light, infrared and the like.

The sensor 5 is received in the space 21 to electrically connect with the lead 22 and to correspond to the LED 3.

The optical element 25 is securely received in the space 21 and is composed of a first lens 251 adjacent to the LED 3 and a second lens 252 adjacent to the sensor 5. The first lens 251 and the second lens 252 are able to integrally formed with a covering 24 of the space 21 of the body 2 or may be attached to a bottom face of the covering 24.

The control element 7 is securely received in the space 21 and is electrically connected to the lead 22. The control element 7 is a control IC (M.C.U).

In this embodiment, the LED 3, the sensor 5, the optical element 25 and the control element 7 are encapsulated inside the space 21 of the body 2. The first lens 251 is so located that the light from the LED 3 is able to pass through the first lens 251 and is refracted by the second lens 252 to be picked up by the sensor 5 and then the control element 7 is able to proceed coordinate encoding and control according to the received signal.

When the optical mouse of the present invention is in use, the body 2 with the LED 3, the sensor 5, the optical element 25 and the control element 7 is able to be attached to the circuit board 61 of the optical mouse 6 having a housing 62 and a base 63. The base 63 has a through hole 631. Therefore, when the LED 3 and the sensor 5 are mounted on the base 63 and on top of the through hole 631, the light from the LED 3 is able to pass through the through hole and the refracted light is able to be picked up by the sensor 5. That is, the light from the LED 3 is first refracted by the first lens 251 and then reflected by the reflection face 1 (table). Thereafter, the light is again refracted by the second lens 252 to be picked up by the sensor 5. Accordingly, the reflection lens 923 used in the conventional optical mouse is eliminated.

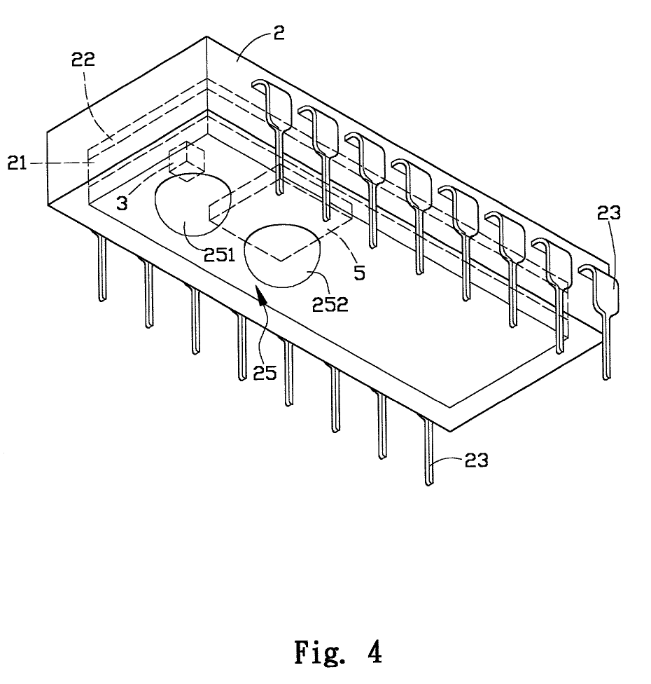

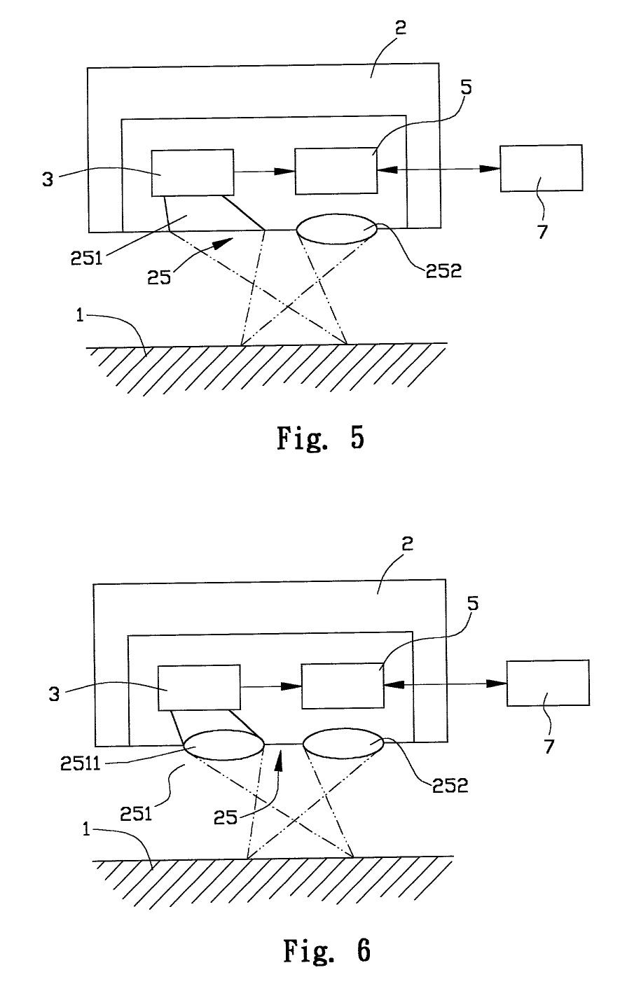

With reference to FIGS. 4 and 5, the optical mouse in accordance with the present invention has a body 2, at least one LED 3 (light emitting diode), a sensor 5 and an optical element 25.

The body 2 has a predetermined space 21 defined inside the body 2 and having at least one lead 22 securely provided inside the space 21 and feet 23 each electrically connected to one of the feet 23.

The LED 3 is mounted inside the space 21 to electrically connect with the lead 22. The LED 3 is at the bottom of the body 2 and is able to emit visible light, infrared and the like.

The sensor 5 is received in the space 21 to electrically connect with the lead 22 and to correspond to the LED 3.

The optical element 25 is securely received in the space 21 and is composed of a first lens 251 adjacent to the LED 3 and a second lens 252 adjacent to the sensor 5. The first lens 251 and the second lens 252 are able to integrally formed with a covering 24 of the space 21 of the body 2 or may be attached to a bottom face of the covering 24.

In this embodiment, the LED 3, the sensor 5, the optical element 25 and the control element 7 are encapsulated inside the space 21 of the body 2. The first lens 251 is so located that the light from the LED 3 is able to pass through the first lens 251 and is refracted by the second lens 252 to be picked up by the sensor 5.

When the optical mouse of the present invention is in use, the body 2 with the LED 3, the sensor 5 and the optical element 25 is able to be attached to the circuit board 61 of the optical mouse 6 having a housing 62 and a base 63. The base 63 has a through hole 631. Therefore, when the LED 3 and the sensor 5 are mounted on the base 63 and on top of the through hole 631, the light from the LED 3 is able to pass through the through hole and the refracted light is able to be picked up by the sensor 5. That is, the light from the LED 3 is first refracted by the first lens 251 and then reflected by the reflection face 1 (table). Thereafter, the light is again refracted by the second lens 252 to be picked up by the sensor 5. Accordingly, the reflection lens 923 used in the conventional optical mouse is eliminated. Also, the optical element 25 may be optional and the LED 3 may be a chip-type LED 3.

With reference to FIG. 6, the third preferred embodiment of the optical mouse shows that the first lens 251 has a convex lens 2511 mounted at a front of the first lens 251.

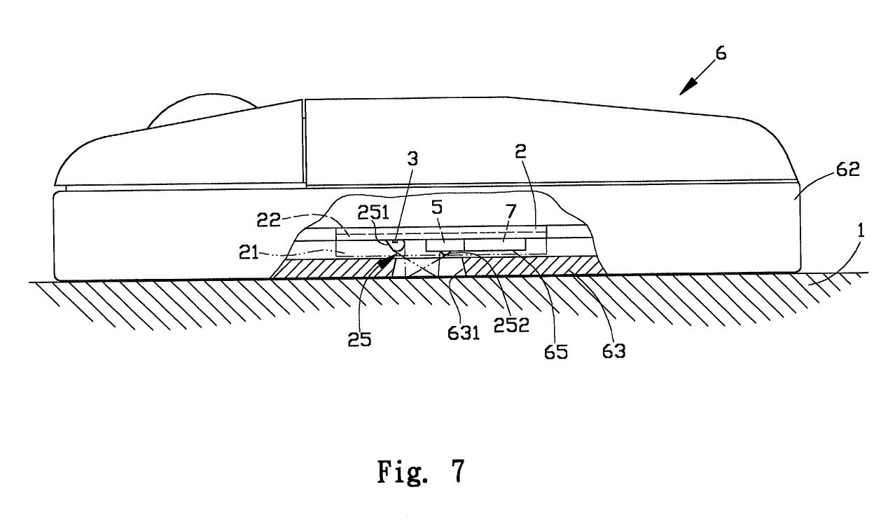

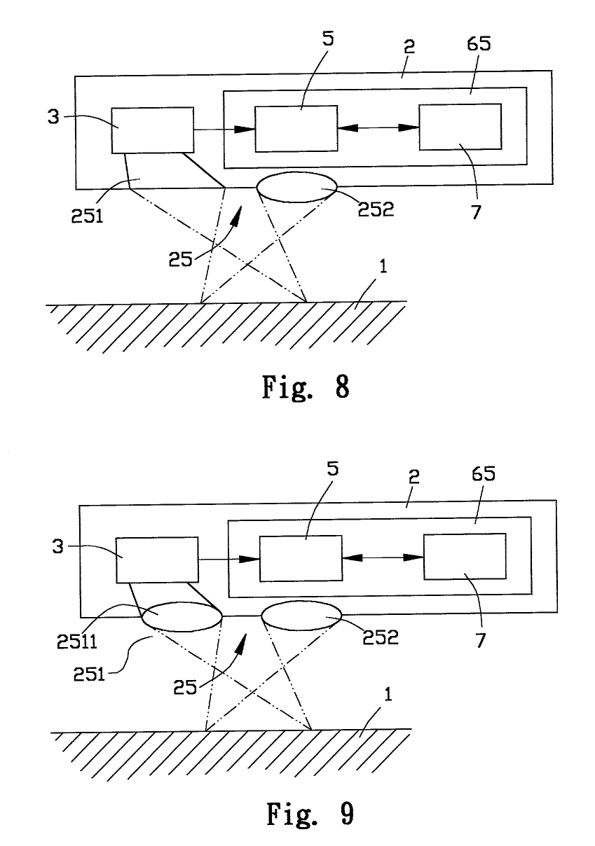

With reference to FIGS. 7 and 8, the fourth embodiment of the optical mouse shows that the sensor 5 and the control element 7 may be formed as an integral sensing body 65 so as to function as the sensor 5 and the control element 7.

With reference to FIG. 9, it is to be noted that the first lens 251 has a convex lens 2511 mounted at a front end of the first lens 251.

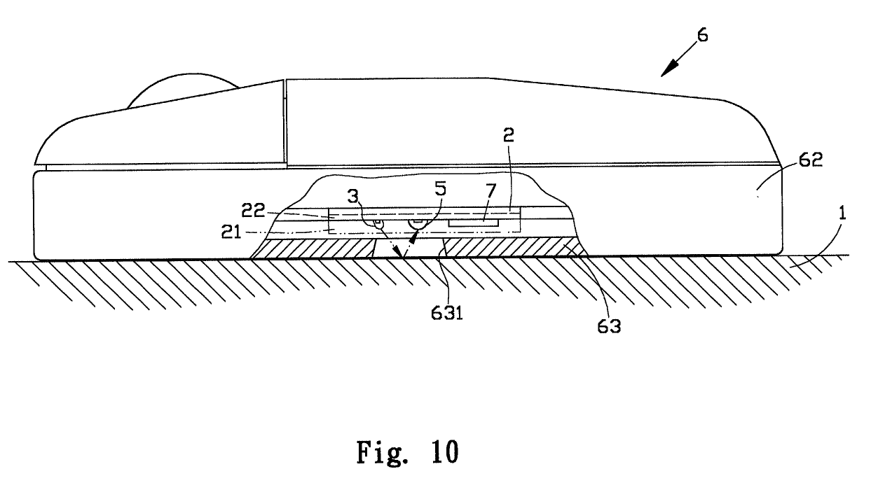

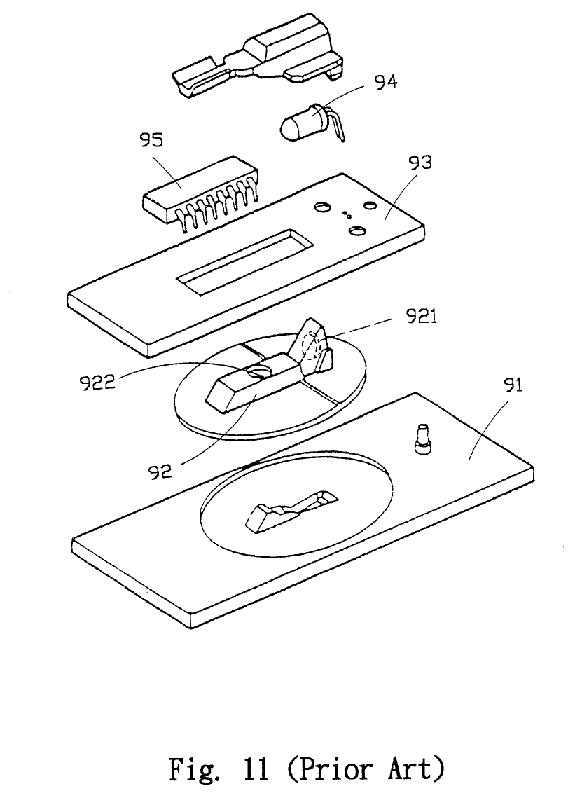

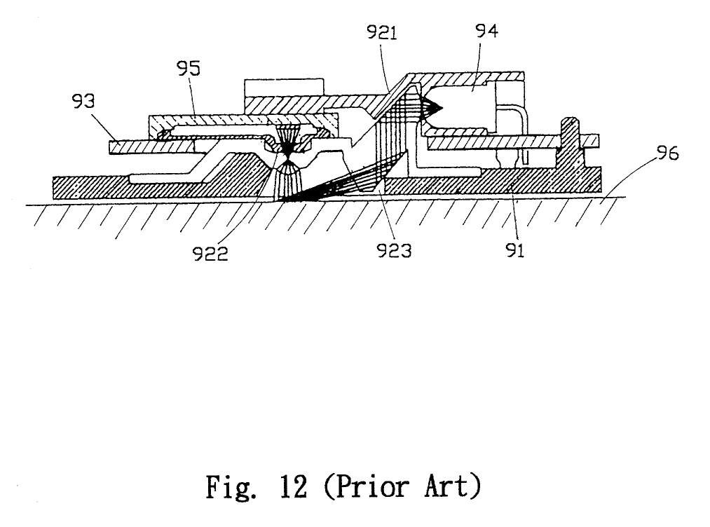

With reference to FIG. 10, the LED 3, the sensor 5 and the control element 7 may be a C.O.B. (Chip On Board) type. In this embodiment, the sensor 5 is a C.O.B. type.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fall extent indicated by the broad general meaning of the terms in which the appended claims are expressed.

What is claimed is:

1. A modulated optical mouse for a personal computer, the optical mouse comprising:
a body having a predetermined space defined inside the body and having at least one lead securely provided inside the space and feet each electrically connected to one of the feet;
at least one light emitting diode mounted inside the space to electrically connect with the lead, the light emitting diode being at a bottom of the body; and
at least one sensor received in the space to electrically connect with the lead and to correspond to the reflective light from reflective surface (table surface) of light emitting diode.

2. The modulated optical mouse as claimed in claim 1 further comprising at least one control element received in the space of the body to be electrically connected to the lead.

3. The modulated optical mouse as claimed in claim 2, wherein the control element is a control IC.

4. The modulated optical mouse as claimed in claim 1 further comprising an optical element received in the space of the body.

5. The modulated optical mouse as claimed in claim 4, wherein the optical element is composed of a light guide element adjacent to the light emitting diode and a second light guide element adjacent to the sensor.

6. The modulated optical mouse as claimed in claim 4, wherein the at least one light emitting diode and the at least one sensor are encapsulated inside the body.

7. The modulated optical mouse as claimed in claim 2, wherein the light emitting diode, the sensor and the control element are C.O.B. type.

8. The modulated optical mouse as claimed in claim 1, wherein the body is so adapted to be attached to a circuit board to align with a through hole in the optical mouse.

9. The modulated optical mouse as claimed in claim 2, the sensor and the control element are integrally formed.

10. A modulated optical mouse for a personal computer, the optical mouse comprising:
a body having a predetermined space defined inside the body and having at least one lead securely provided inside the space and feet each electrically connected to one of the feet;
at least one light emitting diode mounted inside the space to electrically connect with the lead, the light emitting diode being at a bottom of the body;
an optical element securely received in the space and adjacent to the light emitting diode; and
at least one sensor received in the space to electrically connect with the lead and to correspond to the light emitting diode,
whereby the light from the light emitting diode is able to be refracted by the optical element and picked by the sensor.

11. The modulated optical mouse as claimed in claim 10 further comprising at least one control element received in the space of the body to be electrically connected to the lead.

12. The modulated optical mouse as claimed in claim 11, wherein the control element is a control IC.

13. The modulated optical mouse as claimed in claim 10 further comprising an optical element received in the space of the body.

14. The modulated optical mouse as claimed in claim 13, wherein the optical element is composed of a first lens adjacent to the light emitting diode and a second lens adjacent to the sensor.

15. The modulated optical mouse as claimed in claim 10, wherein the at least one light emitting diode and the at least one sensor are encapsulated inside the body.

16. The modulated optical mouse as claimed in claim 11, wherein the light emitting diode, the sensor and the control element are C.O.B. type.

17. The modulated optical mouse as claimed in claim 10, wherein the body is so adapted to be attached to a circuit board to align with a through hole in the optical mouse.

18. The modulated optical mouse as claimed in claim 11, the sensor and the control element are integrally formed.

19. A modulated optical mouse for a personal computer, the optical mouse comprising:
a body having a predetermined space defined inside the body and having at least one lead securely provided inside the space and feet each electrically connected to one of the feet;
at least one light emitting diode mounted inside the space to electrically connect with the lead, the light emitting diode being at a bottom of the body;
an optical element securely received in the space and adjacent to the light emitting diode;
at least one control element received in the space of the body to be electrically connected to the lead; and
at least one sensor received in the space to electrically connect with the lead and to correspond to the light emitting diode,
whereby the light from the light emitting diode is able to be refracted by the optical element and picked by the sensor.
